(19) United States
(12) Patent Application Publication
(10) Pub. No.: US 2019/0271879 A1
(43) Pub. Date: Sep. 5, 2019

(54) LIQUID CRYSTAL PANEL AND IMAGE DISPLAY DEVICE

(71) Applicant: NITTO DENKO CORPORATION, Ibaraki-shi, Osaka (JP)

(72) Inventors: Mizue Yamasaki, Ibaraki-shi (JP); Yusuke Toyama, Ibaraki-shi (JP); Masakuni Fujita, Ibaraki-shi (JP)

(73) Assignee: NITTO DENKO CORPORATION, Ibaraki-shi, Osaka (JP)

(21) Appl. No.: 16/338,141

(22) PCT Filed: Sep. 27, 2017
(86) PCT No.: PCT/JP2017/034981

§ 371 Date: Mar. 29, 2019

(30) Foreign Application Priority Data
Sep. 30, 2016 (JP) 2016-194894

(51) Int. Cl. G02F 1/1335; B32B 5/02; B32B 7/12; C09J 7/38; C09J 7/28; C09J 133/14

(52) U.S. Cl. CPC G02F 1/133528; C09J 2433/00; B32B 7/12; C09J 7/385; C09J 7/28; C09J 133/14; G02F 2202/28; G02F 2201/501; B32B 2307/42; B32B 2262/103; B32B 2457/202; B32B 2307/412; B32B 2307/202; C09J 2203/318; C09J 2400/163; B32B 5/028

(57) ABSTRACT

A liquid crystal panel is disclosed including a pressure-sensitive adhesive layer attached polarizing film which includes a polarizing film including a polarizer and a transparent protective film formed on at least one surface of the polarizer, and a pressure-sensitive adhesive layer formed from a pressure-sensitive adhesive composition on at least one surface of the polarizing film. The polarizing film is bonded through the pressure-sensitive adhesive layer to a transparent conductive layer attached liquid crystal cell in which the transparent conductive layer contains a metal. The transparent protective film has a moisture permeability of 1000 g/(m²·24-hours) or less at 40° C. and 92% RH, the pressure-sensitive adhesive composition includes an ionic compound, and the pressure-sensitive adhesive layer shows a haze value difference of 5.0% or less.

### TECHNICAL FIELD

The present invention relates to a liquid crystal panel to which a transparent conductive layer attached liquid crystal cell in which the transparent conductive layer contains a metal is bonded through a pressure-sensitive adhesive layer of a pressure-sensitive adhesive layer attached polarizing film; and an image display device including the liquid crystal panel.

### BACKGROUND ART

Hitherto, in a liquid crystal panel used in an image display device, a polarizing film is laminated onto a liquid crystal cell with a transparent conductive layer to interpose therebetween a pressure-sensitive adhesive layer. Such a pressure-sensitive adhesive layer for an optical application, such as liquid crystal panels, is required to have a high transparency.

In image display devices, for example, for an electrode of a touch sensor, a transparent conductive layer is frequently used which is yielded by forming a metal oxide layer made of, for example, ITO (indium tin complex oxide) onto a transparent resin film.

For a pressure-sensitive adhesive composition used in image display devices, an acrylic pressure-sensitive adhesive is widely used, which contains a (meth)acrylic polymer. Known is, for example, a pressure-sensitive adhesive layer of a pressure-sensitive adhesive layer attached transparent conductive layer, the pressure-sensitive adhesive layer including an acrylic polymer containing, for monomer units thereof, an alkyl (meth)acrylate having an alkyl group having 2 to 14 carbon atoms (see, for example, Patent Document 1). Known is also, for example, a pressure-sensitive adhesive composition for optical films that includes a (meth)acrylic polymer yielded by polymerizing monomer components containing, as a main component, an alkyl (meth)acrylate having an alkyl group having 4 to 18 carbon atoms, and includes a phosphoric acid ester compound (see, for example, Patent Document 2).

### PRIOR ART DOCUMENTS

### Patent Documents

Patent Document 1: JP-A-2011-016908

Patent Document 2: JP-A-2015-028138

### SUMMARY OF THE INVENTION

### Problems to be Solved by the Invention

In such a situation, when a polarizing film and a transparent conductive layer are laminated onto each other through a pressure-sensitive adhesive layer to which antistatic function is given, the transparent conductive layer may be corroded. The corrosion of the transparent conductive layer is remarkably caused, in particular, in a wet heat environment. It has been newly understood that the transparent conductive layer is corroded by water contained in the pressure-sensitive adhesive layer which contacts the transparent conductive layer, and by a conductive agent for giving antistatic function to the pressure-sensitive adhesive layer. Furthermore, the corrosion of the transparent conductive layer also causes, for example, problems that in a contact interface between the pressure-sensitive adhesive layer and the transparent conductive layer, a peel thereof is caused, or the surface resistance is deteriorated.

About ITO and others as metal oxides used for the transparent conductive layer, a problem of corrosion by water or any conductive agent is hardly caused. Thus, it is conceived that a (single species) metal, alloy and others are used for a transparent conductive layer in which a problem of corrosion is easily generated by water or a conductive agent.

In this case, the following is conceived: the conductive agent added to give antistatic function heightens the water absorption coefficient of the pressure-sensitive adhesive layer, so that water contained in the pressure-sensitive adhesive layer advances the corrosion of the transparent conductive layer containing a metal. It is also conceived that the conductive agent is unevenly precipitated (unevenly distributed) near the interface between the pressure-sensitive adhesive layer and the transparent conductive layer to accelerate the advance of the corrosion of the transparent conductive layer.

The pressure-sensitive adhesive layer described in Patent Document 1 is laid on a surface of a transparent plastic substrate which does not have thereon a transparent conductive layer. Thus, the pressure-sensitive adhesive layer contacts no transparent conductive layer. Consequently, no investigation is made about corrosion based on the pressure-sensitive adhesive layer. In Patent Document 2, an investigation is made about the corrosion of the transparent conductive layer. However, the invention therein is an invention of adding a phosphoric acid ester compound to a pressure-sensitive adhesive layer to restrain the corrosion. Thus, no description is made about any specified conductive agent.

Furthermore, about a liquid crystal panel using a transparent conductive layer attached liquid crystal cell to which a polarizing film is bonded through a pressure-sensitive adhesive layer as described above, after an exposure thereof to a wet heat environment, the pressure-sensitive adhesive layer may become clouded (whiten) when the panel temperature is returned to room temperature. This cloudiness pheromone is generated by the matter that water absorbed in the pressure-sensitive adhesive layer in a wet heat environment is condensed when the panel temperature is returned to room temperature.

Thus, an object of the present invention is to provide a liquid crystal panel about which: even when a polarizing film including a transparent protective film having a specified moisture permeability is laminated to a transparent conductive layer attached liquid crystal cell to interpose therebetween a pressure-sensitive adhesive layer containing an ionic compound that is a conductive agent, the pressure-sensitive adhesive layer is restrained from undergoing a cloudiness phenomenon based on the humidification (wet-heating) of the pressure-sensitive adhesive layer; the pressure-sensitive adhesive layer is improved in durability (restrained from being foamed or peeled off) to restrain the pressure-sensitive adhesive layer surface from being raised in surface resistance to restrain the transparent conductive layer containing a metal from being raised in surface resistance; and further the transparent conductive layer can be restrained from being corroded; and provide an image display device including the liquid crystal panel.

### Means for Solving the Problems

In order to solve the above-mentioned problems, the inventors have repeated eager investigations to find out a pressure-sensitive adhesive composition described below. Thus, the present invention has been accomplished.

Accordingly, the liquid crystal panel of the present invention has a pressure-sensitive adhesive layer attached polarizing film which includes a polarizing film having a polarizer and a transparent protective film formed on at least one surface of the polarizer, and which includes a pressure-sensitive adhesive layer famed from a pressure-sensitive adhesive composition on at least one surface of the polarizing film; and the polarizing film being bonded through the pressure-sensitive adhesive layer to a transparent conductive layer attached liquid crystal cell in which the transparent conductive layer contains a metal; wherein the transparent protective film has a moisture permeability of 1000 g/(m²·24-hours) or less at 40° C. and 92% RH; and the pressure-sensitive adhesive composition includes an ionic compound; the pressure-sensitive adhesive layer shows a haze value difference of 5.0% or less, the difference being represented by the following expression:

expression=[(the haze value (%) of the pressure-sensitive adhesive layer after 30 minutes elapse from the time when the pressure-sensitive adhesive layer is bonded to a glass piece, and the resultant is put in an environment of 60° C. temperature and 95% RH for 120 hours and then taken out into a room temperature environment)−(an initial haze value (%) of the layer)].

It is preferred in the liquid crystal panel of the present invention that the transparent conductive layer containing the metal is a transparent conductive layer containing a metal mesh.

It is preferred in the liquid crystal panel of the present invention that the ionic compound has a molecular weight of 290 or more.

It is preferred in the liquid crystal panel of the present invention that the pressure-sensitive adhesive composition includes a (meth)acrylic polymer, and the (meth)acrylic polymer comprises one or more monomers selected from the group consisting of a carboxyl group-containing, a hydroxyl group-containing, and an amide group-containing monomer; and an alkyl (meth)acrylate as a monomer unit.

The image display device of the present invention preferably includes the liquid crystal panel.

In the liquid crystal panel of the present invention, a pressure-sensitive adhesive layer attached polarizing film using the following polarizing film and pressure-sensitive adhesive layer are bonded through the pressure-sensitive adhesive layer to a transparent conductive layer attached liquid crystal cell in which the transparent conductive layer contains a metal: a polarizing film having a transparent protective film having a specified moisture permeability; and a pressure-sensitive adhesive layer including an ionic compound which is a conductive agent, and is not largely changed in haze value under specified conditions even when the panel is exposed to a wet heat environment. This configuration can usefully provide a liquid crystal panel about which: even in a wet heat environment, the pressure-sensitive adhesive layer is restrained from undergoing a cloudiness phenomenon based on the humidification (wet-heating) of the pressure-sensitive adhesive layer; the pressure-sensitive adhesive layer is improved in durability (restrained from being foamed or peeled off) to restrain the pressure-sensitive adhesive layer surface from being raised in surface resistance to restrain the transparent conductive layer containing the metal (in particular, a metal mesh made of a (single species) metal or alloy) from being raised in surface resistance; and further the transparent conductive layer is restrained from being corroded; and provide an image display device including the liquid crystal panel.

### BRIEF DESCRIPTION OF THE DRAWINGS

FIG. 1 is a sectional view that schematically illustrates an embodiment of the pressure-sensitive adhesive layer attached polarizing film of the present invention.

FIG. 2 is a sectional view that schematically illustrates an embodiment of the image display device of the present invention.

FIG. 3 is a sectional view that schematically illustrates an embodiment of the image display device of the present invention.

FIG. 4 is a sectional view that schematically illustrates an embodiment of the image display device of the present invention.

### 1. PRESSURE-SENSITIVE ADHESIVE COMPOSITION

The pressure-sensitive adhesive composition used in the present invention is a pressure-sensitive adhesive composition for forming a pressure-sensitive adhesive layer of a pressure-sensitive adhesive layer attached polarizing film used in the state of being bonded to a transparent conductive layer attached liquid crystal cell in which the transparent conductive layer contains a metal. The pressure-sensitive adhesive composition contains, as a conductive agent, an ionic compound.

The pressure-sensitive adhesive layer used in the present invention is preferably made of a pressure-sensitive adhesive composition including a base polymer and a crosslinking agent. The pressure-sensitive adhesive composition can be made into, for example, a pressure-sensitive adhesive of, for example, an acrylic, synthetic rubber, rubber, or silicone-based pressure-sensitive adhesive. From the viewpoint of the transparency, the heat resistance and others of the pressure-sensitive adhesive layer, the pressure-sensitive adhesive is preferably an acrylic pressure-sensitive adhesive including, as a base polymer thereof, a (meth)acrylic polymer.

### (1) (Meth)acrylic Polymer

The pressure-sensitive adhesive composition preferably includes a (meth)acrylic polymer. The (meth)acrylic polymer usually contains, as a main component thereof, an alkyl (meth)acrylate for monomer units. The wording “(meth)acrylate” denotes acrylate and/or methacrylate. In the present invention, the word “(meth)a” has substantially the same meaning.

The alkyl (meth)acrylate, which is to constitute the main skeleton of the (meth)acrylic polymer, is, for example, a (meth)acrylate having a linear or branched alkyl group having 1 to 18 carbon atoms. Examples of the alkyl group include methyl, ethyl, propyl, isopropyl, butyl, isobutyl, amyl, hexyl, cyclohexyl, heptyl, 2-ethylhexyl, isooctyl, nonyl, decyl, isodecyl, dodecyl, isomyristyl, lauryl, tridecyl, pentadecyl, hexadecyl, heptadecyl, and octadecyl groups. These groups may be used singly or in combination. In particular, an alkyl (meth)acrylate having a linear or branched alkyl group having 1 to 4 carbon atoms is higher in hydrophilicity to have an effect of dispersing water invading the pressure-sensitive adhesive (layer) in a wet heat environment into this pressure-sensitive adhesive (layer). Thus, the alkyl (meth)acrylate is effective for a restraint of the corrosion, and a restraint of the cloudiness, and further for the durability. In the meantime, an alkyl (meth)acrylate having a linear or branched alkyl group having 5 or more carbon atoms shows a higher hydrophobicity. Thus, water invading the pressure-sensitive adhesive (layer) in a wet heat environment is unevenly precipitated with ease in the interface between the pressure-sensitive adhesive layer and an adherend, so that the adherend is easily deteriorated in corrosion, cloudiness and durability.

The alkyl (meth)acrylate is a compound which is to be a main component in all monomers which constitute the (meth)acrylic polymer. The main component means that in all the monomers constituting the (meth)acrylic polymer, the proportion of the alkyl (meth)acrylate is 70% or more by weight of the monomers. The proportion is preferably from 80 to 99.9% by weight, more preferably from 90 to 99.8% by weight.

In the present invention, it is preferred from the viewpoint of restraining the corrosion of the transparent conductive layer that the (meth)acrylic polymer includes, for monomer units thereof, one or more monomer selected from the group consisting of a carboxyl group-containing monomer, a hydroxyl group-containing monomer, and an amide group-containing monomer. About the carboxyl group-containing monomer, the hydroxyl group-containing monomer, and the amide group-containing monomer, any one thereof may be used, or a combination of two or more thereof may be used. From the viewpoint of the corrosion resistance, the (meth)acrylic polymer most preferably includes the amide group-containing monomer, next preferably includes the hydroxyl group-containing monomer, and next preferably includes the carboxyl group-containing monomer. The addition of an N-vinyl-group-containing lactam monomer, out of amide group-containing monomers, produces an especially high effect of restraining the conductive agent from being unevenly precipitated in the pressure-sensitive adhesive to restrain the surface resistance value of the pressure-sensitive adhesive from being raised, and to make the transparent conductive layer good in corrosion resistance.

As the carboxyl group-containing monomer, the following may be used without any especial limitation: a monomer having a polymerizable functional group having an unsaturated double bond, such as a (meth)acryloyl group or vinyl group, and having a carboxyl group. Examples of the carboxyl group-containing monomer include (meth)acrylic acid, carboxyethyl (meth)acrylate, carboxypentyl (meth)acrylate, itaconic acid, maleic acid, fumaric acid, crotonic acid, and isocrotonic acid. These may be used singly or in any combination. About itaconic acid and maleic acid, respective anhydrides of these acids are usable. Out of these examples, acrylic acid and methacrylic acid are preferred, and acrylic acid is particularly preferred. In general, in a case where a pressure-sensitive adhesive layer containing a polymer including, for monomer units, a carboxyl group-containing monomer is used for a layer containing a metal, such as a transparent conductive layer containing a metal (in particular, a metal mesh made of a (single species) metal or alloy), the metal layer may be corroded due to the carboxyl group. Thus, usually, no carboxyl group-containing monomer is used for a pressure-sensitive adhesive for restraining corrosion. In the present invention, the conductive agent can be improved in dispersibility by incorporating, into the pressure-sensitive adhesive composition, the carboxyl group-containing monomer, the hydroxyl group-containing monomer and/or the amide group-containing monomer, the latter two of these three being to be detailed later. In a pressure-sensitive adhesive layer made of the pressure-sensitive adhesive composition in which the conductive agent is improved in dispersibility, the conductive agent is not unevenly precipitated (unevenly distributed). Thus, this pressure-sensitive adhesive layer favorably gains a greater effect of restraining the corrosion of the transparent conductive layer.

In all the monomers constituting the (meth)acrylic polymer, the proportion of the carboxyl group-containing monomer is preferably 5% by weight or less, more preferably from 0.1 to 3% by weight, even more preferably 0.1 to 1% by weight of the monomers. If the proportion of the carboxyl group-containing monomer is more than 5% by weight, the crosslinkage of the pressure-sensitive adhesive is promoted so that the pressure-sensitive adhesive layer is remarkably hardened about the adhesive property thereof (or is heightened in storage modulus). Thus, in a durability test, the pressure-sensitive adhesive layer unfavorably causes inconveniences such as peeling-off. Moreover, it is preferred in the present invention that the (meth)acrylic polymer contains the carboxyl group-containing monomer in a small amount of about 5% by weight or less since the pressure-sensitive adhesive layer can gain a greater corrosion-restraining effect.

The hydroxyl group-containing monomer is a compound containing, in the structure thereof, a hydroxyl group and a polymerizable unsaturated double bond, such as a (meth)acryloyl group or a vinyl group. Specific examples of the hydroxyl group-containing monomer include 2-hydroxyethyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and other hydroxyalkyl (meth)acrylates; and (4-hydroxymethylcyclohexyl)-methyl acrylate. Out of these hydroxyl group-containing monomers, preferred are 2-hydroxyethyl (meth)acrylate, and 4-hydroxybutyl (meth)acrylate, and particularly preferred is 4-hydroxybutyl (meth)acrylate from the viewpoint of durability of the pressure-sensitive adhesive layer, an even dispersibility of the ionic compound (conductive agent) therein, and the corrosion restraining effect.

In all the monomers constituting the (meth)acrylic polymer, the proportion of the hydroxyl group-containing monomer is preferably from 0.01 to 10% by weight, more preferably from 0.03 to 5% by weight, even more preferably from 0.05 to 3% by weight of the monomers.

The amide group-containing monomer is a compound containing, in the structure thereof, an amide group, and containing a polymerizable unsaturated double bond, such as a (meth)acryloyl group or vinyl group. Specific examples of the amide group-containing monomer include (meth)acrylamide, N,N-dimethyl(meth)acrylamide, N,N-diethyl(meth)acrylamide, N-isopropylacrylamide, N-methyl(meth)acrylamide, N-butyl(meth)acrylamide, N-hexyl(meth)acrylamide, N-methylol(meth)acrylamide, N-methylol-N-propane(meth)acrylamide, aminomethyl(meth)acrylamide, aminoethyl(meth)acrylamide, mercaptomethyl(meth)acrylamide, mercaptoethyl (meth)acrylamide, and other acrylamide monomers; N-(meth)acryloylmorpholine, N-(meth)acryloylpiperidine, N-(meth)acryloylpyrrolidine, and other N-acryloyl heterocyclic monomers; and N-vinylpyrrolidone, N-vinyl-ε-caprolactam, and N-vinyl-group-containing lactam monomers. Out of these examples, N-vinyl-group-containing lactam monomers are preferred.

In all the monomers constituting the (meth)acrylic polymer, the proportion of the amide group-containing monomer is preferably from 0.01 to 10% by weight, more preferably from 0.03 to 7% by weight, in particular preferably from 0.05 to 5% by weight of the monomers. It is preferred in the present invention that the (meth)acrylic polymer contains the amide group-containing monomer in a proportion of about 10% by weight or less since the pressure-sensitive adhesive layer can gain a greater corrosion-restraining effect in the same manner as in the case of adding the hydroxyl group-containing monomer or the carboxyl group-containing monomer to the (meth)acrylic-polymer-synthesis-system.

Besides the alkyl (meth)acrylate, the carboxyl group-containing monomer, the amido group-containing monomer, and the hydroxyl group-containing monomer, and the amido-containing (meth)acrylate, a copolymerizable monomer other than these monomers may be incorporated into the (meth)acrylic polymer as far as the advantageous effects of the present invention are not damaged. In all the monomers constituting the (meth)acrylic polymer, the blend proportion thereof is preferably about 10% by weight or less of the monomers.

The (meth)acrylic polymer in the present invention is usually a (meth)acrylic polymer having a weight average molecular weight (Mw) ranging from 500,000 to 3,000,000. Considering durability, particularly, the heat resistance of the resultant pressure-sensitive adhesive layer, the weight average molecular weight is preferably from 700,000 to 2,700,000. The molecular weight is more preferably from 800,000 to 2,500,000. If the weight average molecular weight is less than 500,000, the crosslinking agent amount needs to be increased so that the flexibility of the crosslinkage is lost. Thus, the pressure-sensitive adhesive layer cannot relieve stress based on the shrinkage of the polarizing film to be unfavorably peeled off in durability. If the weight average molecular weight is more than 3,000,000, a large volume of a diluting solvent unfavorably becomes necessary to adjust the pressure-sensitive adhesive composition into a viscosity for being applied, so that costs are increased. The weight average molecular weight is determined by GPC (gel permeation chromatography) and calculated from polystyrene conversion.

For the production of the (meth)acrylic polymer, a known producing method is appropriately selectable, examples thereof including solution polymerization, bulk polymerization, emulsion polymerization, and various radical polymerizations. The obtained (meth)acrylic polymer may be any one of a random copolymer, a block copolymer, a graft copolymer, and others.

In the solution polymerization, as a polymerizing solvent, for example, ethyl acetate or toluene is used. In a specific example of the solution polymerization, a reaction therefor is conducted in the presence of an added polymerization initiator under the flow of an inert gas, such as nitrogen, ordinarily under conditions of a temperature of about 50 to 70° C. and a period of about 5 to 30 hours.

The polymerization initiator, and a chain transfer agent, an emulsifier and others that are used in each of the radical polymerizations are not particularly limited, and are appropriately selectable to be used. The weight average molecular weight of the (meth)acrylic polymer is controllable by the respective use amounts of the polymerization initiator and the chain transfer agent, and the reaction conditions. The use amounts are appropriately adjusted in accordance with the species of these agents.

Examples of the polymerization initiator include 2,2′-azobisisobutyronitrile, 2,2′-azobis(2-amidinopropane)dihydrochloride, 2,2′-azobis[2-(5-methyl-2-imidazoline-2-yl)propane]dihydrochloride, 2,2′-azobis(2-methylpropionamidine) disulfate, 2,2′-azobis(N,N′-dimethyleneisobutylamidine), 2,2′-azobis[N-(2-carboxyethyl)-2-methylpropionamidine] hydrate (trade name: VA-057, manufactured by Wako Pure Chemical Industries, Ltd.), and other azo initiators; potassium persulfate, ammonium persulfate, and other persulfates; di(2-ethylhexyl) peroxydicarbonate, di(4-t-butylcyclohexyl) peroxydicarbonate, di-sec-butyl peroxydicarbonate, t-butyl peroxyneodecanoate, t-hexyl peroxypivalate, t-butyl peroxypivalate, dilauroyl peroxide, di-n-octanoyl peroxide, 1,1,3,3-tetramethylbutyl peroxy-2-ethylhexanoate, di(4-methylbenzoyl) peroxide, dibenzoyl peroxide, t-butyl peroxyisobutyrate, 1,1-di(t-hexylperoxy) cyclohexane, t-butyl hydroperoxide, hydrogen peroxide, and other peroxide initiators; and any combination of a persulfate with sodium hydrogensulfite; and redox initiators in each of which a peroxide is combined with a reducing agent, such as a combination of a peroxide with sodium ascorbate. However, the polymerization initiator is not limited to these examples.

Such polymerization initiators may be used singly or in the form of a mixture of two or more thereof. The content of the whole of the polymerization initiator(s) is preferably from about 0.005 to 1 parts by weight, more preferably from about 0.02 to 0.5 parts by weight for 100 parts by weight of all the monomers constituting the (meth)acrylic polymer.

In order to use, as the polymerization initiator, for example, 2,2′-azobisisobutyronitrile to produce a (meth)acrylic polymer having a weight average molecular weight in any one of the above-mentioned ranges, the use amount of the polymerization initiator is preferably from about 0.06 to 0.2 parts by weight, more preferably from about 0.08 to 0.175 parts by weight for 100 parts by weight of all the monomers constituting the (meth)acrylic polymer.

In the case of using the chain transfer agent, and the emulsifier or reactive emulsifier used in the emulsion polymerization, these may be appropriate agents known in the prior art. The respective addition amounts of these agents may be appropriately decided as far as the advantageous effects of the present invention are not damaged.

### (2) Ionic Compound (Conductive Agent)

The pressure-sensitive adhesive composition contains an ionic compound (conductive agent). By using the ionic compound, the pressure-sensitive adhesive layer can ensure antistatic function. When the pressure-sensitive adhesive layer contains the ionic compound, it is feared that a transparent conductive layer is corroded which contains a metal (in particular, a metal mesh made of a (single species) metal or alloy) and which contacts the pressure-sensitive adhesive layer. In particular, in a wet heat environment, it is feared that the ionic compound in the pressure-sensitive adhesive layer is unevenly precipitated (unevenly distributed) at a side of the pressure-sensitive adhesive layer that contacts the metal-containing transparent conductive layer so that the transparent conductive layer is corroded. Thus, the ionic compound is preferably a compound having a molecular weight (molar molecular weight) of 290 or more. The molecular weight is preferably 380 or more, more preferably 400 or more, even more preferably 500 or more, in particular preferably 600 or more. The use of the ionic compound having a molecular weight of 290 or more allows to restrain the corrosion of the transparent conductive layer, and further restrain the pressure-sensitive adhesive layer surface from being raised in surface resistance to restrain, for example, the metal-containing transparent conductive layer from being raised in surface resistance. As the molecular weight of the ionic compound is larger, the pressure-sensitive adhesive layer containing the ionic compound is lower in water absorption coefficient, and the uneven distribution is less easily caused in the interface at which the pressure-sensitive adhesive layer contacts the transparent conductive layer. Thus, the transparent conductive layer can be restrained from being corroded. The upper limit value of the molecular weight of the ionic compound is not particularly limited, and is preferably 2000 or less since the pressure-sensitive adhesive layer can ensure antistatic function to attain a compatibility of antistatic function with durability.

If the molecular weight of the ionic compound (conductive agent) is less than 290, it is conceivable that the pressure-sensitive adhesive layer becomes high in water absorption coefficient so that water contained in the pressure-sensitive adhesive layer advances the corrosion of the transparent conductive layer. If the molecular weight of the ionic compound is less than 290, the molecular weight is small. Thus, it is conceivable that in the pressure-sensitive adhesive layer, the ionic compound is easily shifted near the interface between the pressure-sensitive adhesive layer and the transparent conductive layer to be unevenly precipitated (unevenly distributed) so that the ionic compound near the interface causes the corrosion. It is conceivable that in the pressure-sensitive adhesive layer, the ionic compound tends to be unevenly precipitated in a large proportion near the interface between the pressure-sensitive adhesive layer and the transparent conductive layer, so that the ionic compound near the interface accelerates the advance of the corrosion. These phenomena are remarkably caused in the transparent conductive layer. Moreover, the phenomena are remarkably caused also in a wet heat environment. In the present invention, the ionic compound having a molecular weight of 290 or more is used. This molecular weight is large; thus, also in a wet heat environment, the ionic compound is not shifted with ease in the pressure-sensitive adhesive layer, and is not unevenly precipitated with ease, so that the pressure-sensitive adhesive layer easily keeps a state that the ionic compound is evenly distributed therein. As a result, the transparent conductive layer would be restrained from being corroded.

The ionic compound (conductive agent) is preferably an ionic compound having an anionic component and a cationic component. A description will be made about the cationic component and the anionic component.

### <Anionic Component of Ionic Compound>

In the present invention, the total number of carbon atoms in the anionic component is not particularly limited, and is preferably 6 or more, more preferably 8 or more. The upper limit value of the total carbon atom number in the anionic component is not particularly limited, and is preferably 16 or less, more preferably 10 or less. When the total carbon atom number of the anionic component is 6 or more, the hydrophobicity of the ionic compound itself becomes high so that the pressure-sensitive adhesive layer less easily contains water. Consequently, the corrosion of the transparent conductive layer can be favorably restrained.

The anionic component preferably has an organic group. The organic group is preferably an organic group having 3 or more carbon atoms, more preferably an organic group having 4 or more carbon atoms.

The molecular weight of the ionic compound is preferably 290 or more; and the molecular weight of the anionic component is not particularly limited, and is preferably 100 or more, more preferably 200 or more, even more preferably 300 or more. When the molecular weight of the anionic component is in any one of these ranges, the ionic compound itself becomes high in hydrophobicity; thus, the pressure-sensitive adhesive layer less easily contains therein water so that the corrosion of the transparent conductive layer can be favorably restrained. The upper limit of the molecular weight of the anionic component is not particularly limited, and is preferably 1000 or less since the pressure-sensitive adhesive layer can ensure antistatic function to attain a compatibility of antistatic function with durability.

From the viewpoint of restraining the corrosion, the anionic component is preferably at least one of respective anionic components represented by at least one selected from the following general formula (1)

(CₙF₂ₙ₊₁SO₂)₂N⁻ (1)

wherein n is an integer from 1 to 10 (preferably from 3 to 10); the following general formula (2):

CF₂(CₙF₂ₙSO₂)₂N⁻ (2)

wherein m is an integer from 1 to 10 (preferably from 2 to 10); and the following general formula (3):

—O₃S(CF₂)₁SO₃⁻ (3)

wherein 1 is an integer from 1 to 10 (preferably from 3 to 10).

Specific examples of the anionic component represented by the general formula (1) include a bis(trifluoromethanesulfonyl)imide anion, a bis(heptafluoropropanesulfonyl)imide anion, a bis(nonafluorobutanesulfonyl)imide anion, a bis(undecafluoropentanesulfonyl)imide anion, a bis(tridecafluorohexanesulfonyl)imide anion, and a bis(pentadecafluoroheptanesulfonyl)imide anion. Out of these examples, preferred are a bis(trifluoromethanesulfonyl)imide anion, and a bis(nonafluorobutanesulfonyl)imide anion. In particular preferred is a bis(nonafluorobutanesulfonyl)imide anion.

A specific example of the anionic component represented by the general formula (2) is a cyclo-hexafluoropropane-1,3-bis(sulfonyl)imide anion. This anion is favorably usable.

A specific example of the anionic component represented by the general formula (3) is a hexafluoropropane-1,3-disulfonate anion. This anion is favorably usable.

### (Cationic Component of Ionic Compound)

In the present invention, the cationic component is preferably an organic cation. The total carbon atom number of the cation is preferably 6 or more, more preferably 8 or more, even more preferably 10 or more. The upper limit value of the total carbon atom number of the cation is not particularly limited, and is preferably 40 or less, more preferably 30 or less. When the total carbon atom number of the cationic component is 6 or more, the ionic compound itself becomes high in hydrophobicity so that the pressure-sensitive adhesive layer does not easily come to contain therein water. Consequently, the corrosion of the transparent conductive layer can be favorably restrained.

The cationic component preferably has an organic group. The organic group is preferably an organic group having 3 or more carbon atoms, more preferably an organic group having 7 or more carbon atoms.

In the present invention, the use of the above-mentioned organic cation is preferred. The cationic component is preferably a cationic component which permits the molecular weight of the ionic compound to be set into 290 or more. It is preferred to use, as the cationic component, an ion of an alkali metal that is lithium, sodium or potassium since a small addition amount thereof produces a great effect of lowering the surface resistance value.

When the cationic component of the ionic compound is an organic cation, the cationic component is combined with the anionic component to constitute an organic cation-anion salt as the ionic compound. The organic cation-anion salt is also called an ionic liquid or ionic solid. Specific examples of the organic cation include a pyridinium cation, a piperidinium cation, a pyrrolidinium cation, a cation having a pyrroline skeleton, a cation having a pyrrole skeleton, an imidazolium cation, a tetrahydropyrimidinium cation, a dihydropyrimidinium cation, a pyrazolium cation, a pyrazolinium cation, a tetraalkylammonium cation, a trialkylsulfonium cation, and a tetraalkylphosphonium cation.

Specific examples of the organic cation-anion salt may be salts selected appropriately from compounds each made of a combination of any one of the cationic components with any one of the anionic components; and include butylmethylimidazolium bis(nonafluorobutanesulfonyl)imide, N-butyl-methylpyridinium bis(nonafluorobutanesulfonyl)imide, methylpropylpyrrolidinium bis(nonafluorobutanesulfonyl)imide, 1-butyl-3-methylpyridinium bis(heptafluoropropanesulfonyl)imide, 1-butyl-3-methylpyridinium bis(nonafluorobutanesulfonyl)imide, 1-butyl-3-methylpyridinium cyclo-hexafluoropropane-1,3-bis(sulfonyl)imide, bis(1-butyl-3-methylpyridinium) hexafluoropropane-1,3-disulfonic acid, 1-ethyl-3-methylimidazolium bis(heptafluoropropanesulfonyl)imideimide, 1-ethyl-3-methylimidazolium bis(nonafluorobutanesulfonyl)imide, 1-ethyl-3-methylimidazolium cyclo-hexafluoropropane-1,3-bis(sulfonyl)imide, bis(1-ethyl-3-methylpyridinium) hexafluoropropane-1,3-disulfonic acid, methyltrioctylammonium bis(trifluoromethanesulfonyl)imide, methyltrioctylammonium bis(nonafluorobutanesulfonyl)imide, hexylmethylpyridinium bis(trifluoromethanesulfonyl)imide, ethylmethylpyrrolidinium bis(trifluoromethanesulfonyl)imide, methylpropylpyrrolidinium bis(trifluoromethanesulfonyl)imide, butylmethylpiperidinium bis(trifluoromethanesulfonyl)imide, methyltrioctylammonium bis(fluorosulfonyl)imide, and 1-decylpyridinium bis(trifluoromethanesulfonyl)imide.

Specific examples of the alkali metal salt containing, as the cationic component, an alkali metal ion include lithium bis(heptafluoropropanesulfonyl)imide, sodium bis(heptafluoropropanesulfonyl)imide, potassium bis(heptafluoropropanesulfonyl)imide, lithium bis(nonafluorobutanesulfonyl)imide, sodium bis(nonafluorobutanesulfonyl)imide, and potassium bis(nonafluorobutanesulfonyl)imide.

The use amount of the ionic compound in the pressure-sensitive adhesive composition of the present invention is preferably from 0.001 to 10 parts by weight, more preferably from 0.1 to 5 parts by weight, even more preferably from 0.3 to 3 parts by weight for 100 parts by weight of the (meth)acrylic polymer. If the amount of the ionic compound is less than 0.001 parts by weight, the effect of lowering the surface resistance value becomes poor. In the meantime, if the amount of the ionic compound is more than 10 parts by weight, the transparent conductive layer may be deteriorated in corrosion resistance or durability.

### (3) Crosslinking Agent

The pressure-sensitive adhesive composition of the present invention may contain a crosslinking agent besides the above-mentioned components. The use of the crosslinking agent is preferred because it can impart cohesive strength of the pressure-sensitive adhesive relating to durability of the pressure-sensitive adhesive. The crosslinking agent may be an organic-based crosslinking agent or a polyfunctional metal chelate. Examples of the organic-based crosslinking agent include isocyanate-based crosslinking agents, peroxide-based crosslinking agents, epoxy-based crosslinking agents, and imine-based crosslinking agents. The polyfunctional metal chelate is a substance in which a polyvalent metal is bonded to an organic compound through covalent bonding or coordinate bonding. Examples of the polyvalent metal include Al, Cr, Zr, Co, Cu, Fe, Ni, V, Zn, In, Ca, Mg, Mn, Y, Ce, Sr, Ba, Mo, La, Sn, and Ti. The covalent-bonded or coordination-bonded atom in the organic compound is, for example, an oxide atom. Examples of the organic compound include alkyl esters, alcohol compounds, carboxylic acid compounds, ether compounds, and ketone compounds.

In the pressure-sensitive adhesive composition of the present invention, the use amount of the crosslinking agent is preferably from 0.01 to 5 parts by weight, more preferably from 0.03 to 2 parts by weight for 100 parts by weight of the (meth)acrylic polymer.

### (4) Others

The pressure-sensitive adhesive composition of the present invention may further contain other known additives. For example, the following may be appropriately added to the composition in accordance with the usage thereof: a silane coupling agent that may be of various types, a polyether compound of a polyalkylene glycol such as polypropylene glycol, a colorant, a powder such as pigment, a dye, a surfactant, a plasticizer, a tackifier, a surface lubricant, a levelling agent, a softener, an antioxidant, an antiaging agent, a light stabilizer, an ultraviolet absorbent, a polymerization inhibitor, an inorganic or organic filler, a metallic powder, or a particulate- or foil-form material.

### 2. PRESSURE-SENSITIVE ADHESIVE LAYER

The pressure-sensitive adhesive layer of the present invention is made of the pressure-sensitive adhesive composition.

The method for forming the pressure-sensitive adhesive layer is, for example, a method of applying the pressure-sensitive adhesive composition onto, for example, a separator subjected to releasing treatment, and drying/removing a polymerization solvent and others therein to form the pressure-sensitive adhesive layer. The pressure-sensitive adhesive layer may also be produced by, for example, a method of applying the pressure-sensitive adhesive composition onto a polarizing film that will be detailed later, and drying/removing a polymerization solvent and others therein to form the pressure-sensitive adhesive layer on the polarizing film. In the application of the pressure-sensitive adhesive composition, one or more solvents other than the polymerizing solvent may be newly added appropriately to the composition.

The separator subjected to releasing treatment is preferably a silicone release liner. When the pressure-sensitive adhesive composition of the present invention is applied onto such a liner and then dried to form the pressure-sensitive adhesive layer, the method for drying the pressure-sensitive adhesive may be a suitable method selected appropriately in accordance with a purpose. Preferably, the method is the above-mentioned applied-film heating and drying method. The temperature for the heating and the drying is preferably from 40° C. to 200° C., more preferably from 50° C. to 180° C., in particular preferably from 70° C. to 170° C. When the heating temperature is set in any one of these ranges, a pressure-sensitive adhesive can be yielded which has very good adhesive properties.

About the drying period, a suitable period is appropriately adoptable. The drying period is preferably from 5 seconds to 20 minutes, more preferably from 5 seconds to 10 minutes, in particular preferably from 10 seconds to 5 minutes.

The method for applying the pressure-sensitive adhesive composition may be any one of various methods. Specific examples thereof include roll coating, kiss roll coating, gravure coating, reverse coating, roll brushing, spray coating, dip roll coating, bar coating, knife coating, air knife coating, curtain coating, lip coating, and extrusion coating using, for example, a die coater.

The thickness of the pressure-sensitive adhesive layer (after the drying thereof) is not particularly limited, and is, for example, from about 1 to 100 μm, and is preferably from 2 to 50 μm, more preferably from 2 to 40 μm, even more preferably from 5 to 35 μm. If the thickness of the pressure-sensitive adhesive layer is less than 1 μm, the pressure-sensitive adhesive layer becomes poor in adhesiveness to an adherend to tend to be insufficient in durability in a wet heat environment. In the meantime, if the thickness of the pressure-sensitive adhesive layer is more than 100 μm, the pressure-sensitive adhesive composition is not sufficiently dried when the pressure-sensitive adhesive composition is applied and dried in the formation of the pressure-sensitive adhesive layer, so that foams remain and thickness unevenness is generated in the pressure-sensitive adhesive layer. Thus, external appearance problems of the pressure-sensitive adhesive layer tend to become apparent easily.

The pressure-sensitive adhesive layer used in the present invention shows a haze value difference of 5.0% or less, this difference being represented by an expression described below. When the haze value difference (haze difference) of the pressure-sensitive adhesive layer is as small as 5.0%, a change in the haze value is small even in the case of exposing the pressure-sensitive adhesive layer to a wet heat environment for a long period. In other words, the water content in the pressure-sensitive adhesive layer is small to restrain the corrosion of the transparent conductive layer, which contains a metal (in particular, a metal mesh made of a (single species) metal or alloy) and which contacts the pressure-sensitive adhesive layer, and further to restrain a cloudiness phenomenon of the pressure-sensitive adhesive layer that is caused by humidifying (wet-heating) the pressure-sensitive adhesive layer. Thus, this embodiment is a preferred embodiment. The haze difference is preferably 4.0% or less, more preferably 3.0% or less. When the pressure-sensitive adhesive layer is made small in haze difference, the corrosion of the transparent conductive layer can be further restrained; this case is useful. If the haze difference is more than 5.0%, the pressure-sensitive adhesive layer is poor in viewability (cloudiness-phenomenon-restrainability) so that the restraint of the corrosion may unfavorably become difficult.

expression=[(the haze value (%) of the pressure-sensitive adhesive layer after 30 minutes elapse from the time when the pressure-sensitive adhesive layer is bonded to a glass piece, and the resultant is put in an environment of 60° C. temperature and 95% RH for 500 hours and then taken out into a room temperature environment)−(an initial haze value (%) of the layer)].

About the pressure-sensitive adhesive layer (including the ionic compound) used in the present invention, the water content (saturated water content) in the pressure-sensitive adhesive layer is preferably 3% or less by weight, in the state that the pressure-sensitive adhesive layer does not include the ionic compound, after the pressure-sensitive adhesive layer is allowed to stand still at 23° C. and 55% RH for 5 hours and after the pressure-sensitive adhesive layer is allowed to stand still at 60° C. and 90% RH for 5 hours. The composition of the pressure-sensitive adhesive layer is not particularly limited. The water content in the pressure-sensitive adhesive layer is more preferably 2% by weight or less, even more preferably 1.3% or less by weight in the state that the pressure-sensitive adhesive layer does not include the ionic compound. If the water content in the pressure-sensitive adhesive layer is more than 3% by weight in the state that the pressure-sensitive adhesive layer does not include the ionic compound, the pressure-sensitive adhesive layer becomes large in water content therein in the state of containing the ionic compound. Thus, the pressure-sensitive adhesive layer may be deteriorated in corrosion resistance or foamed in a wet heat environment to tend to be deteriorated in durability.

### 3. PRESSURE-SENSITIVE ADHESIVE LAYER ATTACHED POLARIZING FILM

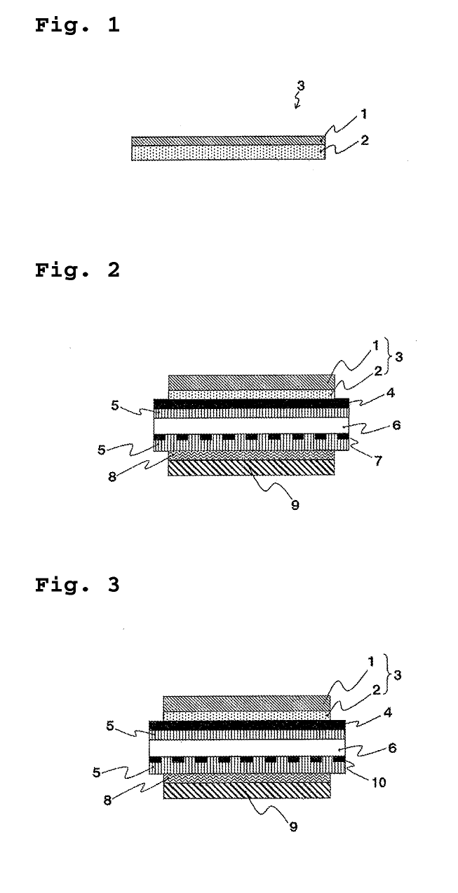

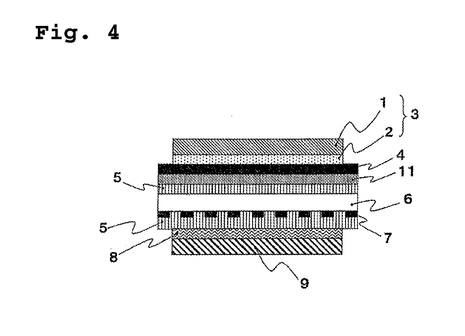

The pressure-sensitive adhesive layer attached polarizing film used in the present invention has a polarizing film including a polarizer and a transparent protective film on at least one surface of the polarizer, and which has a pressure-sensitive adhesive layer made of a pressure-sensitive adhesive composition and formed on at least one surface of the polarizing film. As illustrated in, for example, FIG. 1, a pressure-sensitive adhesive layer attached polarizing film 3 used in the present invention is a film in which a polarizing film 1 and a pressure-sensitive adhesive layer 2 are laminated onto each other. Moreover, as illustrated in each of FIGS. 2 to 4, a pressure-sensitive adhesive layer attached polarizing film 3 used in the present invention is used in the state of being bonded to a transparent conductive layer 4 of a transparent conductive layer attached liquid crystal cell (glass substrate 5+liquid crystal layer 6+glass substrate 5) in which the transparent conductive layer contains a metal.

The method for forming the pressure-sensitive adhesive layer is as described above.

In a case where about the pressure-sensitive adhesive layer attached polarizing film used in the present invention, its pressure-sensitive adhesive layer is famed on a separator subjected to releasing treatment, the pressure-sensitive adhesive layer attached polarizing film can be formed by transferring the pressure-sensitive adhesive layer on the separator onto a transparent protective film surface of a polarizing film. The pressure-sensitive adhesive layer attached polarizing film can be also formed by applying the pressure-sensitive adhesive composition directly onto a polarizing film and drying/removing a polymerization solvent and others therein.

The pressure-sensitive adhesive layer may be formed after an anchor layer is famed onto the surface of the polarizing film on which the pressure-sensitive adhesive composition is to be applied, or after the surface is subjected to corona treatment, plasma treatment, or any other easily-bonding treatment that may be of various types. An easily-bonding treatment may be applied onto the surface of the pressure-sensitive adhesive layer.

When the pressure-sensitive adhesive layer is exposed in the pressure-sensitive adhesive layer attached polarizing film, the pressure-sensitive adhesive layer may be protected with a sheet subjected to releasing treatment (separator) until the pressure-sensitive adhesive layer is bonded to the metal-containing transparent conductive layer.

Examples of the material for forming the separator include plastic films such as polyethylene, polypropylene, polyethylene terephthalate, and polyester film; porous material such as paper, cloth and nonwoven fabric; and appropriate thin sheets such as net, foamed sheet, metal foil, and laminate thereof. In particular, plastic film is preferably used, because of its good surface smoothness.

The plastic films are not particularly limited as long as the films are each a film capable of protecting the pressure-sensitive adhesive layer. Examples thereof include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the separator is usually from about 5 to 200 μm, preferably from about 5 to 100 μm. As required, the separator may be subjected to a releasing and antifouling treatment with, for example, a silicone-based, fluorine-based, long-chain alkyl-based or aliphatic acid amide-based releasing agent, or silica powder, or to an antistatic treatment of, for example, a coating type, kneading and mixing type, or vapor-deposition type. The peelability of the separator from the pressure-sensitive adhesive layer can be made higher, particularly, by subjecting the surface of the separator appropriately to a releasing treatment, such as silicone treatment, long-chain alkyl treatment or fluorine treatment.

The sheet subjected to releasing treatment, which is used to produce the pressure-sensitive adhesive layer attached polarizing film, is usable, as it is, as a separator for the pressure-sensitive adhesive layer attached polarizing film. Thus, the production of the film can be simplified from the viewpoint of a process therefor.

As the polarizing film, a polarizing film is used which has a polarizer and a transparent protective film famed on at least one surface of the polarizer.

The polarizer is not particularly limited, and may be a polarizer that may be of various types. Examples of the polarizer include a product yielded by causing a dichronic substance, such as iodine or a dichronic dye, to be adsorbed onto a hydrophilic polymer film, such as a polyvinyl alcohol-based film, a partially formylated polyvinyl alcohol-based film or an ethylene/vinyl acetate copolymer based-partially-saponified film, and then stretching the resultant uniaxially; and a polyene-based aligned film made of, for example, a polyvinyl-alcohol-dehydrated product or a polyvinyl-chloride dehydrochloride-treated product. Out of these examples, preferred is a polarizer made of a polyvinyl alcohol film, and a dichronic substance such as iodine. More preferred is an iodine-based polarizer containing iodine and/or an iodine ion. The thickness of each of these polarizers is not particularly limited, but is generally from about 5 to 80 μm.

The polarizer in which a polyvinyl alcohol-based film dyed with iodine has uniaxially stretched can be produced, for example, by immersing a polyvinyl alcohol into an aqueous solution of iodine to be dyed, and then stretching the resultant film into a length 3 to 7 times the original length of this film. As required, the stretched film may be immersed into an aqueous solution of, for example, potassium iodide which may contain, for example, boric acid, zinc sulfite or zinc chloride. Furthermore, before the dyeing, the polyvinyl alcohol-based film may be immersed into water as required to be cleaned with water. The cleaning of the polyvinyl alcohol-based film with water can clean stains and a blocking-preventing agent on surfaces of the polyvinyl alcohol-based film, and further produce an advantageous effect of swelling the polyvinyl alcohol-based film to prevent unevenness of the dyeing and any other unevenness. The stretching may be performed after the dyeing with iodine or while the dyeing is performed. Alternatively, after the stretching, the dyeing with iodine may be performed. The stretching may be performed in an aqueous solution of, for example, boric acid or potassium iodide, or in a water bath.

In the present invention, a thin polarizer having a thickness of 10 μm or less may be used. From the viewpoint of making the polarizing film thinner, the thickness is preferably from 1 to 7 μm. Such a thin polarizer is favorable in that the polarizer is small in thickness unevenness, excellent in viewability and is small in dimension change to be excellent in durability; and further makes the resultant polarizing film also thin.

Typical examples of the thin polarizer include thin polarizing membranes described in JP-A-S51-069644, JP-A-2000-338329, the pamphlet of WO 2010/100917, the pamphlet of WO 2010/100917, the specification of Japanese Patent No. 4751481, and JP-A-2012-073563. These thin polarizing membranes can each be yielded by a producing method including the step of stretching a polyvinyl alcohol-based resin (hereinafter referred to also as a PVA-based resin) layer and a resin substrate for stretching in a laminate state, and the step of dyeing the laminate. On the basis of the supporting of the PVA-based resin layer on the resin substrate for stretching, this producing method allows to stretch the laminate without causing inconveniences, such as breaking by the stretching, even when the PVA-based resin layer is thin.

The thin polarizing membranes are preferably polarizing membranes each yielded by the following producing method, out of producing methods including the step of stretching the members concerned in a laminate state thereof and the step of dyeing the laminate, since the laminate can be stretched into a high stretch ratio to improve the resultant in polarizing performance: a producing method including the step of stretching the laminate in an aqueous solution of boric acid, as is described in the pamphlet of WO 2010/100917, the pamphlet of WO 2010/100917, the specification of Japanese Patent No. 4751481, and JP-A-2012-073563. The membranes are in particular preferably membranes each yielded by a producing method including the step of stretching the laminate supplementally in the air before the stretching in the aqueous solution of boric acid, as is described in the specification of Japanese Patent No. 4751481, and JP-A-2012-073563.

About the transparent protective film used in the present invention, the moisture permeability thereof is 1000 g/(m²·24-hours) or less at 40° C. and 92% RH. As the transparent protective film, any transparent conductive layer is usable without especial limitation as far as the moisture permeability thereof is adjusted into the range. When the moisture permeability of the transparent protective film is adjusted into the range, water can be prevented from invading the pressure-sensitive adhesive layer, which contacts the transparent protective film, and the cloudiness phenomenon can be further restrained to prevent, usefully, the corrosion of the transparent conductive layer, which contains the metal (in particular, a metal mesh made of a (single species) metal or alloy) and contacts the pressure-sensitive adhesive layer. The moisture permeability of the transparent protective film is preferably 600 g/(m²·24-hours) or less, more preferably 300 g/(m²·24-hours) or less, even more preferably 200 g/(m²·24-hours) or less, in particular preferably 100 g/(m²·24-hours) or less. If the moisture permeability of the transparent protective film is more than 1000 g/(m²·24-hours), the amount of water invading the pressure-sensitive adhesive layer increases so that the transparent conductive layer may be corroded, and the liquid crystal panel itself may be unfavorably deteriorated in durability. If the transparent protective film is heighted in moisture permeability, the dimensional change rate of the transparent protective film itself increases in a wet heat environment. This matter is unfavorable from the viewpoint of the humidification durability. As the transparent protective film is lower in moisture permeability, the surface of the pressure-sensitive adhesive layer contacting the transparent protective film can be further restrained from being raised in surface resistance value. For example, when water invading the inside of the pressure-sensitive adhesive layer is circulated in a humidifying (wet heat) environment, it is conceived that water volatilizes from the transparent protective film-containing polarizing film side thereof. At this time, the conductive agent component (ionic compound) in the pressure-sensitive adhesive layer is partially shifted toward the polarizing film. In this way, the conductive agent component is decreased in the pressure-sensitive adhesive layer surface contacting the polarizing film, so that the pressure-sensitive adhesive layer surface is raised in surface resistance value. In the meantime, when the transparent protective film included in the polarizing film is low in moisture permeability, the water can be prevented from invading the pressure-sensitive adhesive layer. Thus, it is presumed that the pressure-sensitive adhesive layer surface can be restrained from being raised in surface resistance value to restrain the surface resistance value of the transparent conductive layer surface which contacts the pressure-sensitive adhesive layer surface and which contains the metal (in particular, a metal mesh made of a (single species) metal or alloy). For reference, ITO of the metal oxide layer and the like tends not to be easily affected (corroded) by the ionic compound contained in the pressure-sensitive adhesive layer. However, not the use of ITO or the like but the use of the metal-containing transparent conductive layer is a more preferable embodiment since a finer line and a pattern are easily famed.

The material constituting the transparent protective film may be a thermoplastic resin which is excellent not only in the above-mentioned moisture permeability but also in transparency, mechanical strength, thermal stability, water blocking performance isotropy and others. Specific examples of the thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic polyolefin resins (norbornene resins), polyarylate resins, polystyrene resins, and polyvinyl alcohol resins; and mixtures of two or more of these resins. The transparent protective film may contain one or more appropriate additives selected at will. Examples of the dopant(s) include an ultraviolet absorbent, an antioxidant, a lubricant, a plasticizer, a releasing agent, a coloring preventive, a flame retardant, a nucleating agent, an antistatic agent, a pigment and a colorant. The content of the thermoplastic resin in the transparent protective film is preferably from 50 to 100% by weight, more preferably from 50 to 99% by weight, even more preferably from 60 to 98% by weight, in particular preferably from 70 to 97% by weight. If the content of the thermoplastic resin in the transparent protective film is 50% or less by weight, it is feared that a high transparency and others that the thermoplastic resin originally has cannot be sufficiently expressed.

The transparent protective film is bonded through an adhesive layer to at least one side of the polarizer. For the treatment of bonding the polarizer to the transparent protective film, an adhesive is used. Examples of the adhesive include isocyanate-based adhesives, polyvinyl alcohol-based adhesives, gelatin-based adhesives, vinyl latex-based adhesives, and water-based polyester adhesives. The adhesive is usually used as an adhesive made of an aqueous solution, and usually contains 0.5 to 60% by weight of solid. The adhesive for the bonding between the polarizer and the transparent protective film is, for example, an ultraviolet curable adhesive or electron beam curable adhesive besides the above-mentioned adhesives. The electron beam curable adhesive for polarizing films shows a favorable adhesion property to the above-mentioned various transparent protective films. A metal compound filler may be incorporated into the adhesive used in the present invention.

The pressure-sensitive adhesive layer attached polarizing film used in the present invention is, for example, a film in the state of bonding the pressure-sensitive adhesive layer onto a transparent conductive layer of a transparent conductive layer attached liquid crystal cell in which this transparent conductive layer contains a metal (in particular, a metal mesh made of a (single species) metal or alloy). The shape or form of the metal used in the transparent conductive layer is not particularly limited, and examples thereof include the form of a flat plate having no gaps, the form of a pattern having gaps, and a metal mesh yielded by patterning a fine line. For example, the transparent conductive layer containing the metal mesh is a layer yielded by fo ling a metal mesh in which a metallic fine line is fo fled into a lattice pattern. The corrosion resistance effect according to the present invention is remarkably produced, particularly, for a metal mesh using a highly corrosive metallic fine line.

The metal constituting the metal mesh may be any appropriate metal as far as the metal is a metal high in electroconductivity. The metal constituting the metal mesh is preferably one or more metals selected from the group consisting of gold, platinum, silver, aluminum, and copper. From the viewpoint of the electroconductivity of the mesh, aluminum, silver, copper or gold is preferred. Particularly preferred is a metal mesh having a structure containing, as a metal, aluminum since the mesh remarkably produces the corrosion resistance effect.

The transparent conductive layer containing the metal mesh may be famed by any appropriate method. The transparent conductive layer can be yielded, for example, by coating a photosensitive composition containing a silver salt (transparent-conductive-layer-forming composition) onto an adherend such as a releasing film, and then applying light-exposing treatment and developing treatment to the resultant to make the metallic fine line into a predetermined pattern. The line width and the shape of the metallic fine pattern are not particularly limited. The line width is preferably 10 μm or less. The transparent conductive layer can also be yielded by printing a paste containing fine metallic particles (transparent-conductive-layer-forming composition) into a predetermined pattern. Details of such a transparent conductive layer and a forming method thereof are described in JP-A-2012-18634. The description therein is incorporated into the present description for reference. Another example of the transparent conductive layer containing the metal mesh (or made of the metal mesh) and a forming method thereof may be a transparent conductive layer and a forming method thereof that are described in JP-A-2003-331654. The metal mesh may be formed by, for example, sputtering or ink-jetting, in particular preferably sputtering.

The thickness of the transparent conductive layer is preferably from about 0.01 to 10 μm, more preferably from about 0.05 to 3 μm, even more preferably from 0.1 to 1 μm.

The transparent conductive layer may have an overcoat (OC) layer (not illustrated) on the transparent conductive layer.

As the overcoat layer, an overcoat layer used ordinarily used in the present field may be used without especial limitation. The overcoat layer is a layer made of, for example, an alkyd resin, acrylic resin, epoxy resin, urethane resin or isocyanate resin. The thickness of the overcoat layer is not particularly limited, and is preferably, for example, from 0.1 to 10 μm.

### 4. LIQUID CRYSTAL PANEL

The liquid crystal panel of the present invention has a pressure-sensitive adhesive layer attached polarizing film including a polarizing film having a polarizer and a transparent protective film on at least one surface of the polarizer, and including the pressure-sensitive adhesive layer made of the pressure-sensitive adhesive composition on at least one surface of the polarizing film; and the polarizing film is bonded through the pressure-sensitive adhesive layer to a transparent conductive layer attached liquid crystal cell in which the conductive layer contains a metal (in particular, a metal mesh made of a (single species) metal or alloy). Other constituents thereof are not particularly limited. In the present invention, by setting the following into respective appropriate ranges, the liquid crystal panel can be restrained from undergoing cloudiness as a whole, and can be improved in durability and others: the moisture permeability of the transparent protective film included in the polarizing film, the haze difference of the pressure-sensitive adhesive layer, and others.

### 5. IMAGE DISPLAY DEVICE

The image display device of the present invention preferably includes the liquid crystal panel. Hereinafter, a description will be made about a liquid crystal display device as an example. However, the present invention is applicable to all display devices requiring a liquid crystal panel.

Specific examples of an image display device to which the liquid crystal panel of the present invention is applicable include a liquid crystal display device, an electroluminescence (EL) display, a plasma display panel (PD), and a field emission display (FED).

It is sufficient that the image display device of the present invention includes the liquid crystal panel of the present invention. Other constituents thereof are equivalent to those of image display devices in the prior art.

### EXAMPLES

Hereinafter, the present invention will be specifically described by way of Examples thereof. However, the invention is not limited by these Examples. In each Example, parts and percentages are all on a weight basis. Conditions for allowing any object to stand still at room temperature are wholly 23° C. and 55% RH unless otherwise specified.

### Production Example 1 (Preparation of Acrylic Polymer (A-1))

Into a four-necked flask equipped with stirring fans, a thermometer, a nitrogen introducing tube and a condenser was charged a monomer mixture including 95.5 parts of butyl acrylate, 4 parts of N-vinylpyrrolidone, 0.4 parts of 4-hydroxybutyl acrylate, and 0.1 parts of acrylic acid. Furthermore, into 100 parts by (a solid in) the monomer mixture was charged ethyl acetate together with 0.2 parts of 2,2′-azobisisobutyronitrile as a polymerization initiator. While this system was gently stirred, nitrogen gas was introduced into the flask to purge the inside thereof with nitrogen. Thereafter, while the liquid temperature of the inside of the flask was kept about 55° C., the polymerizable components were caused to undergo a polymerization reaction for 8 hours. Thereafter, ethyl acetate was added to the resultant reaction solution to prepare a solution of an acrylic polymer (A-1) having a weight-average molecular weight of 1,800,000 in which the solid concentration was 16%.

### Production Example 2 (Preparation of Acrylic Polymer (A-2))

A solution of an acrylic polymer (A-2) having a weight-average molecular weight of 2,000,000 was prepared in the same way as in Production Example 1 except that as the monomer mixture in Production Example 1, a monomer mixture was used which contained 96.9 parts of butyl acrylate, 3 parts of acrylic acid, and 0.1 parts of hydroxyethyl acrylate.

### Production Example 3 (Preparation of Acrylic Polymer (A-3))

A solution of an acrylic polymer (A-3) having a weight-average molecular weight of 1,700,000 was prepared in the same way as in Production Example 1 except that as the monomer mixture in Production Example 1, a monomer mixture was used which contained 98 parts of butyl acrylate, and 2 parts of 4-hydroxybutyl acrylate.

### Production Example 4 (Preparation of Acrylic Polymer (A-4))

A solution of an acrylic polymer (A-4) having a weight-average molecular weight of 1,600,000 was prepared in the same way as in Production Example 1 except that as the monomer mixture in Production Example 1, a monomer mixture was used which contained 99.8 parts of 2-ethylhexyl acrylate and 0.2 parts of hydroxyethyl acrylate.

The weight-average molecular weight of each of the resultant (meth)acrylic polymers was measured by the following method:

### <Measurement of Weight-Average Molecular Weight of Each (Meth)Acrylic Polymer>

The weight-average molecular weight of the (meth)acrylic polymer was measured, using GPC (gel permeation chromatography).

Analyzer: HLC-8120GPC, manufactured by Tosoh Corp.,

Columns: G7000H_{XL}+GMH_{XL}+GMH_{XL}, manufactured by Tosoh Corp.,

Size of each of the columns: 7.8 mm in diameter×30 cm in length; total length: 90 cm,

Column temperature: 40° C.,

Flow rate: 0.8 mL/min.,

Injected volume: 100 μL,

Eluent: tetrahydrofuran,

Detector: differential reflector (RI), and

Standard sample: polystyrene.

### Production Example 5 (Method for Producing Polarizing Film)

A polyvinyl alcohol film having a thickness of 80 μm was stretched 3 times between rolls different from each other in speed rate while dyed with an iodine solution having a concentration of 0.3% and a temperature of 30° C. for 1 minute. Thereafter, the film was stretched into a total stretch ratio of 6 times while immersed in an aqueous solution of 60° C. which contained boric acid in a concentration of 4% and potassium iodide in a concentration of 10% for 0.5 minutes. Next, the film was immersed in an aqueous solution of 30° C. which contained potassium iodide in a concentration of 1.5% for 10 seconds to be washed, and then the film was dried at 50° C. for 4 minutes to yield a polarizer of 20 μm thickness. A polyvinyl alcohol-based adhesive was used to bond transparent protective films shown in Table 1 and used in each of Examples and Comparative Examples, respectively, onto both surfaces of the polarizer to produce each polarizing film.

### Production Example 6 (Preparation of Pressure-Sensitive Adhesive Composition Using Acrylic Polymer (A-1))

Into 100 parts of a solid in the acrylic polymer (A-1) yielded in Production Example 1 were blended 0.15 parts of an isocyanate crosslinking agent (trade name: TAKENATE D160N, trimethylolpropanehexamethylenediisocyanate, manufactured by Mitsui Chemicals, Inc.), 0.3 parts of benzoyl peroxide (trade name: NYPER BMT, manufactured by NOF Corp.), and 0.2 parts of γ-glycidoxypropylmethoxysilane (trade name: KBM-403, manufactured by Shin-Etsu Chemical Co., Ltd.) to prepare a pressure-sensitive adhesive composition.

### Production Example 7 (Preparation of Pressure-Sensitive Adhesive Composition Using Acrylic Polymer (A-2))

About a pressure-sensitive adhesive composition prepared from the acrylic polymer (A-2) solution yielded in Production Example 2, this pressure-sensitive adhesive composition was prepared in the same way as in Production Example 6 except that the isocyanate crosslinking agent was changed to 0.5 parts of an isocyanate crosslinking agent (trade name: CORONATE L, trimethylolpropane/tolylenediisocyanate, manufactured by Nippon Polyurethane Industry Co., Ltd.), and the peroxide was changed to 0.2 parts of benzoyl peroxide (trade name: NYPER BMT, manufactured by NOF Corp.)

### Production Example 8 (Preparation of Pressure-Sensitive Adhesive Composition Using Acrylic Polymer (A-3))

About a pressure-sensitive adhesive composition prepared from the acrylic polymer (A-3) solution yielded in Production Example 3, this pressure-sensitive adhesive composition was prepared in the same way as in Production Example 6 except that the isocyanate crosslinking agent was changed to 0.1 parts of an isocyanate crosslinking agent (trade name: TAKENATE D110N, trimethylolpropanexylylenediisocyanate, manufactured by Mitsui Chemicals, Inc.).

### Production Example 9 (Preparation of Pressure-Sensitive Adhesive Composition Using Acrylic Polymer (A-4))

About a pressure-sensitive adhesive composition prepared from the acrylic polymer (A-4) solution yielded in Production Example 4, this pressure-sensitive adhesive composition was prepared in the same way as in Production Example 6 except that the isocyanate crosslinking agent was changed to 0.15 parts of an isocyanate crosslinking agent (trade name: TAKENATE D110N, trimethylolpropanexylylenediisocyanate, manufactured by Mitsui Chemicals, Inc.).

### Example 1

### (Preparation of Pressure-Sensitive Adhesive Composition)

Into the pressure-sensitive adhesive composition in Production Example 6 was further blended 1 part of lithium bis(nonafluorobutanesulfonyl)imide (trade name: EF-N445, manufactured by Mitsubishi Materials Corp.) as an ionic compound (conductive agent) to prepare an acrylic pressure-sensitive adhesive solution.

### (Production of Pressure-Sensitive Adhesive Layer Attached Polarizing Film)

Next, a fountain coater was used to paint the acrylic pressure-sensitive adhesive composition solution evenly onto a surface of a polyethylene terephthalate film treated with a silicone release agent (separator film). The resultant was dried at 155° C. in an air-circulating type constant-temperature oven for 2 minutes to form a pressure-sensitive adhesive layer of 20 μm thickness onto the front surface of the separator film. Next, a transparent protective film shown in Table 1 was used to transfer the pressure-sensitive adhesive layer famed on the separator film onto the polarizing film produced in accordance with Production Example 5. In this way, each pressure-sensitive adhesive layer attached polarizing film was produced.

### Examples 2 to 13, and Comparative Examples 1 to 5

In each of Examples 2 to 13, and Comparative Examples 1 to 5, an ionic compound shown in Table 1 was blended into the pressure-sensitive adhesive composition yielded in one of Production Examples 6 to 9 to give the same molar concentration as in Example 1 to prepare an acrylic pressure-sensitive adhesive solution. Each polarizing film, and each pressure-sensitive adhesive layer attached polarizing film were produced in the same way as in Example 1 except that changes shown in Table 1 were made.

Evaluations described below were made about the transparent protective films, the pressure-sensitive adhesive layers (in the state of containing no ionic compound), and the pressure-sensitive adhesive layer attached polarizing films which were used in Examples and Comparative Examples. The evaluation results are shown in Table 2. About samples in each of which one of the pressure-sensitive adhesive layer attached polarizing films was bonded to a conductive glass piece corresponding to a transparent conductive layer attached liquid crystal cell, evaluations thereof are also show in Table 2.

### <Measurement of Moisture Permeability of Transparent Protective Film>

A water vapor permeability measuring device (PERMATRAN-W, manufactured by MOCON, Inc.) was used to measure the water vapor permeability (moisture permeability) (g/(m²·24-hours) of the transparent protective film included in any one of the polarizing films in each of the examples in an atmosphere of 40° C. and 92% RH over 24 hours. The measurement was made in accordance with JIS K7129B.

### <Method for Measuring Water Content (Saturated Water Content) in Pressure-Sensitive Adhesive Layer Containing No Ionic Compound>

In connection with the pressure-sensitive adhesive layer of any one of the pressure-sensitive adhesive layer attached polarizing films produced in each of Examples and Comparative Examples, a pressure-sensitive adhesive layer to which no ionic compound as a conductive agent was added was prepared under the same conditions as used in the above-mentioned method for producing the pressure-sensitive adhesive layer attached polarizing film, using the pressure-sensitive adhesive composition prepared in one of Production Examples 6 to 9. From this pressure-sensitive adhesive layer, a sample of about 50 mg weight was collected. A water absorbing/adsorbing measuring device (IGA-Sorp, manufactured by Hiden Inc.) was used to remove water completely from the sample at 100° C. for 1 hour. In this state, the weight (W1) of the sample was measured. Next, the sample was allowed to stand still at 23° C. and 55% RH for 5 hours, and at 60° C. and 90% RH for 5 hours. A change in the weight was then observed. When the weight change of the sample came not to be observed (the sample turned in a saturated state), the weight (W2) thereof was measured. In accordance with the following expression, the water content (saturated water content) (% by weight) was measured:

$$Saturated water content ( \% by weight ) = \frac{W 2 - W 1}{W 1} \times 100$$

### <Haze Difference (Humidifying Cloudiness Test)>

Any one of the pressure-sensitive adhesive layer attached polarizing films yielded in each of Examples and Comparative Examples was cut into a piece of 50 mm×50 mm size. Therefrom, the separator was peeled off, and the surface of the pressure-sensitive adhesive layer was bonded to an alkali glass piece (manufactured by Matsunami Glass Ind., Ltd.; thickness: 1.1 mm), and then the resultant was put in an autoclave at 50° C. and 5 atm for 15 minutes. The resultant was used as a measuring sample for a cloudiness test. This sample was allowed to stand still at room temperature for 30 minutes, and then an initial haze value thereof was measured (measurement result: 0.7%). Subsequently, the measuring sample was put in an environment of 60° C. temperature and 95% RH for 500 hours, and then taken out at room temperature. After 10 minutes, the haze value (%) thereof was measured (after the sample was heated to be made cloud). The haze value was measured, using a haze meter HM150 manufactured by Murakami Color Research Laboratory Co., Ltd. In Table 2, the haze difference (%) was gained from the difference between the haze values that is shown according to the following expression:

expression=[(the haze value (%) of the pressure-sensitive adhesive layer after 30 minutes elapse from the time when the pressure-sensitive adhesive layer is bonded to a glass piece, and the resultant is put in an environment of 60° C. temperature and 95% RH for 500 hours and then taken out into a room temperature environment)−(an initial haze value (%) of the layer)].

### <Surface Resistance Value>

From any one of the pressure-sensitive adhesive layer attached polarizing films yielded in each of Examples and Comparative Examples, the separator film was peeled off. The pressure-sensitive adhesive layer attached polarizing film was allowed to stand still at room temperature for one minute, and then the surface resistance value of the surface of the pressure-sensitive adhesive layer was measured. This was used as the initial surface resistance value (Ω/□) thereof. Subsequently, this sample was put in a humidifying environment of 60° C. temperature and 95% RH for 500 hours, and further dried at 40° C. for 1 hour. Thereafter, the surface resistance value of the surface of the pressure-sensitive adhesive layer was measured, using a device MCP-HT450 manufactured by Mitsubishi Chemical Analytec Co., Ltd. This measurement result was used as the surface resistance value (Ω/□) of the sample after the wet heating. For reference, the surface resistance value is preferably less than 3.0×10¹²Ω/□ (less than 3.0E+12Ω), and is more preferably less than 1.0×10¹²Ω/□.

### <Durability Test>

Any one of the pressure-sensitive adhesive layer attached polarizing films yielded in each of Examples and Comparative Examples was cut into a piece of 15 inch size. From this sample, the separator film was peeled off and a laminator was used to bond the resultant onto a non-alkali glass piece (EG-XG, manufactured by Corning Inc.) of 0.7 mm thickness. Next, the resultant was subjected to autoclave treatment at 50° C. and 0.5 MPa for 15 minutes to bond the sample completely on the non-alkali glass piece. The sample subjected to this treatment was treated in an atmosphere of 60° C. temperature and 95% RH for 500 hours (humidifying test). The external appearance between the polarizing film and the glass piece was evaluated by visual observation in accordance with the following criterion.

### (Evaluation Criterion)

∪: The sample never has any external appearance such as peeling-off.

∘: The sample is slightly peeled off at an end thereof, but no practical problem is caused.

Δ: The sample is peeled off at an end thereof, but no practical problem is caused for others than especial articles.

x: The sample has at an end thereof remarkable peeling-off to have a practical problem.

### <Corrosion Test>

Any one of the pressure-sensitive adhesive layer attached polarizing films yielded in each of Examples and Comparative Examples was cut into a piece of 15 mm×15 mm size. Therefrom, the separator film was peeled off. This was bonded onto a conductive glass piece in which an aluminum-based metallic layer of 0.1 μm thickness that was famed by sputtering was formed on a surface of a glass (non-alkali glass) piece. Thereafter, the resultant was put in an autoclave at 50° C. and 5 atm for 15 minutes. The resultant was used as a corrosion-resistance measuring sample (sample yielded by bonding the pressure-sensitive adhesive layer attached polarizing film onto the conductive glass piece corresponding to a transparent conductive layer attached liquid crystal cell). The resultant measuring sample was put in an environment of 60° C. temperature and 95% RH for 500 hours (or was wet-heated), and subsequently the external appearance of its aluminum-based metallic layer was evaluated visually and through an optical microscope. About the size of a defect, the longest moiety of the defect was measured.

Instead of the conductive glass piece, Example 13 made use of amorphous ITO (an ITO film (manufactured by GEOMATEC Co., Ltd.; thickness: 50 nm; Sn percentage in the amorphous ITO thin film: 3% by weight) formed on one surface of a non-alkali glass piece by sputtering) to evaluate the corrosion resistance thereof.

### (Evaluation Criterion)

5: The sample has no defects.
4: The sample slightly has at a partial periphery thereof defects (defect size: less than 0.5 mm), but has therein no defects so that no practical problem is caused.
3: The sample has at the periphery thereof intermittent defects (defect size: 0.5 mm or more, and less than 1 mm), but has therein no defects so that no practical problem is caused.
2: The sample has at the periphery thereof intermittent defects (defect size: 1 mm or more, and less than 2 mm), but has therein no defects so that no practical problem is caused.
1: The sample has at the periphery thereof continuous defects (defect size: 2 mm or more), or has therein defects so that a practical problem is caused.

TABLE 1

| | Acrylic pressure- | | | | | |
|---|---|---|---|---|---|---|
| | sensitive adhesive | | | | | |
| | composition | | | | | |
| | | Ionic component | | Transparent | | |
| | | (conductive | | protective film | | |
| | Acrylic | agent) | | | Moisture | |
| | polymer | | Molecualr | | permeability | Metallic |
| | Species | Species | weight | Species | (g/(m² · day)) | layer |
| Example 1 | A-1 | Li-NFSI | 587 | COP | 6.5 | Metal |
| Example 2 | A-1 | MTOA- | 948 | COP | 6.5 | Metal |
| | | NFSI | | | | |
| Example 3 | A-1 | EMI-TFSI | 391 | COP | 6.5 | Metal |
| Example 4 | A-1 | EMI-FSI | 291 | COP | 6.5 | Metal |
| Example 5 | A-1 | Dcpy- | 500 | COP | 6.5 | Metal |
| | | TFSI | | | | |
| Example 6 | A-1 | MTOA- | 948 | Acryl | 110 | Metal |
| | | NFSI | | (40) | | |
| Example 7 | A-1 | MTOA- | 948 | Acryl | 240 | Metal |
| | | NFSI | | (25) | | |
| Example 8 | A-1 | MTOA-FSI | 548 | COP | 6.5 | Metal |
| Example 9 | A-2 | MTOA- | 948 | COP | 6.5 | Metal |
| | | NFSI | | | | |
| Example | A-3 | MTOA- | 948 | COP | 6.5 | Metal |
| 10 | | NFSI | | | | |
| Example | A-3 | Dcpy- | 500 | COP | 6.5 | Metal |
| 11 | | TFSI | | | | |
| Example | A-4 | MTOA- | 948 | COP | 6.5 | Metal |
| 12 | | NFSI | | | | |
| Example | A-1 | Li-NFSI | 587 | COP | 6.5 | ITO |
| 13 | | | | | | |
| Comparative | A-2 | EMI-FSI | 291 | COP | 6.5 | Metal |
| Example 1 | | | | | | |
| Comparative | A-4 | EMI-TFSI | 391 | COP | 6.5 | Metal |
| Example 2 | | | | | | |
| Comparative | A-1 | Li-TFSI | 287 | COP | 6.5 | Metal |
| Example 3 | | | | | | |
| Comparative | A-1 | Li-TFSI | 287 | TAC(40) | 1100 | Metal |
| Example 4 | | | | | | |
| Comparative | A-3 | Li-TFSI | 287 | COP | 6.5 | Metal |
| Example 5 | | | | | | |

In Table 1, abbreviates are as follows:
<Ionic Compounds (Conductive agents)>
MTOA-NFSI: methyltrioctylammonium bis(nonafluorobutanesulfonyl)imide,
MTOA-FSI: methyltrioctylammonium bis(fluorosulfonyl)imide,
Li-NFSI: lithium bis(nonafluorobutanesulfonyl)imide,
Li-TFSI: lithium bis(trifluoromethanesulfonyl)imide,
Dcpy-TFSI: 1-decylpyridinium bis(trifluoromethanesulfonyl)imide,
EMI-FSI: ethylmethylimidazolium bis(fluorosulfonyl)imide, and
EMI-TFSI: ethylmethylimidazolium bis(trifluoromethanesulfonyl)imide.
<Transparent Protective Films>
COP: A cyclic polyolefin (cycloolefin polymer) film
(ZEONOR manufactured by Zeon Corp.; moisture permeability: 6.5 g/m²/24-hours) of 25 μm thickness was subjected to corona treatment, and the resultant was used.
ACRYL (40): A (meth)acrylic resin having a lactone ring structure (moisture permeability: 110 g/m²/24-hours) and having thickness of 40 μm was subjected to corona treatment, and the resultant was used.
ACRYL (25): A (meth)acrylic resin having a lactone ring structure (moisture permeability: 240 g/m²/24-hours) and having thickness of 25 μm was subjected to corona treatment, and the resultant was used.
TAC(40): A triacetylacellulose film (manufactured by Fuji Film Co., Ltd.; moisture permeability: 1100 g/m²/24-hours) of 40 μm thickness was subjected to saponification treatment, and the resultant was used.

TABLE 2

| | | | Haze | | | | |
|---|---|---|---|---|---|---|---|
| | Water | | difference | Surface | | | |
| | content | | [%] | Resistance | | | |
| | [% by | | “Value after | value [Ω/□] | | | Corrosion |
| | weight] | | humidification | | 60° C. | | test |
| | 23° C. | 60° C. | into | | and | Durability | 60° C. and |
| | and | and | cloudiness” - | | 95% RH | 60° C. and | 95% RH |
| | 55% | 95% | “initial | | for | 95% RH | for |
| | RH | RH | value” | Initial | 500 hr. | for 500 hr. | 500 hr. |
| Example 1 | 0.6 | 1.2 | 1.9 | 4.0E+11 | 4.2E+11 | ⊚ | 5 |
| Example 2 | 0.6 | 1.2 | 2.0 | 7.4E+11 | 7.6E+11 | ◯ | 5 |
| Example 3 | 0.6 | 1.2 | 2.6 | 2.5E+11 | 2.7E+11 | ⊚ | 5 |
| Example 4 | 0.6 | 1.2 | 2.8 | 2.3E+11 | 2.5E+11 | ⊚ | 4 |
| Example 5 | 0.6 | 1.2 | 2.8 | 5.4E+11 | 5.6E+11 | ⊚ | 5 |
| Example 6 | 0.6 | 1.2 | 1.8 | 7.6E+11 | 8.5E+11 | ⊚ | 4 |
| Example 7 | 0.6 | 1.2 | 1.5 | 7.9E+11 | 9.2E+11 | ⊚ | 3 |
| Example 8 | 0.6 | 1.2 | 2.5 | 3.8E+11 | 4.1E+11 | ⊚ | 4 |
| Example 9 | 0.5 | 1.2 | 3.0 | 9.0E+11 | 9.2E+11 | ◯ | 4 |
| Example | 0.3 | 0.8 | 3.4 | 8.6E+11 | 8.8E+11 | ◯ | 3 |
| 10 | | | | | | | |
| Example | 0.3 | 0.8 | 4.7 | 7.5E+11 | 7.9E+11 | ◯ | 2 |
| 11 | | | | | | | |
| Example | 0.1 | 0.4 | 3.7 | 1.1E+12 | 2.5E+12 | Δ | 2 |
| 12 | | | | | | | |
| Example | 0.6 | 1.2 | 1.9 | 4.0E+11 | 4.2E+11 | ⊚ | 5 |
| 13 | | | | | | | |
| Comparative | 0.5 | 1.2 | 5.3 | 4.5E+11 | 5.4E+11 | ◯ | 1 |
| Example 1 | | | | | | | |
| Comparative | 0.1 | 0.4 | 6.8 | 8.9E+11 | 9.8E+11 | X | 1 |
| Example 2 | | | | | | | |
| Comparative | 0.6 | 1.2 | 5.1 | 1.6E+11 | 1.7E+11 | ⊚ | 1 |
| Example 3 | | | | | | | |
| Comparative | 0.6 | 1.2 | 1.1 | 4.0E+11 | 1.1E+12 | Δ | 1 |
| Example 4 | | | | | | | |
| Comparative | 0.3 | 0.8 | 6.5 | 2.7E+11 | 2.9E+11 | Δ | 1 |
| Example 5 | | | | | | | |

From the evaluation results in Table 2, it has been able to be verified that all Examples are good in all the evaluations of transparency (restrain of a cloudiness phenomenon), antistatic property, corrosion resistance, and durability. In the meantime, it has been able to be verified that: all Comparative Examples were poor in corrosion resistance; Comparative Examples 1 to 3 and 5 have a haze value difference more than 5.0% to be poor in viewability (restrain of a cloudiness phenomenon) as well as in corrosion resistance; and Comparative Example 4, which makes use of the TAC film, in which the moisture permeability of the transparent protective film is 1100 g/m²/24-hours, is poorer in corrosion resistance than Examples.

### DESCRIPTION OF REFERENCE SIGNS

1 Polarizing film
2 Pressure-sensitive adhesive Layers
3 Pressure-sensitive adhesive layer-attached polarizing Film
4 Transparent conductive layer containing a metal mesh
5 Glass substrate
6 Liquid crystal layer
7 Driving electrode
8 Pressure-sensitive adhesive Layer
9 Polarizing film
10 Driving-electrode-concurrently-functioning sensor layer
11 Sensor Layer

1. A liquid crystal panel: comprising a pressure-sensitive adhesive layer attached polarizing film which comprises a polarizing film comprising a polarizer and a transparent protective film formed on at least one surface of the polarizer, and a pressure-sensitive adhesive layer formed from a pressure-sensitive adhesive composition on at least one surface of the polarizing film; and the polarizing film being bonded through the pressure-sensitive adhesive layer to a transparent conductive layer attached liquid crystal cell in which the transparent conductive layer contains a metal;
wherein the transparent protective film has a moisture permeability of 1000 g/(m²·24-hours) or less at 40° C. and 92% RH,
the pressure-sensitive adhesive composition comprises an ionic compound, and
the pressure-sensitive adhesive layer shows a haze value difference of 5.0% or less, the haze value difference being represented by an expression:
expression=[(the haze value (%) of the pressure-sensitive adhesive layer after 30 minutes elapse from the time when the pressure-sensitive adhesive layer is bonded to a glass piece, and the resultant is put in an environment of 60° C. temperature and 95% RH for 500 hours and then taken out into a room temperature environment)−(an initial haze value (%) of the layer)].

2. The liquid crystal panel according to claim 1, wherein the transparent conductive layer containing the metal is a transparent conductive layer containing a metal mesh.

3. The liquid crystal panel according to claim 1, wherein the ionic compound has a molecular weight of 290 or more.

4. The liquid crystal panel according to claim 1, wherein the pressure-sensitive adhesive composition comprises a (meth)acrylic polymer, and
the (meth)acrylic polymer comprises one or more monomers selected from the group consisting of a carboxyl group-containing monomer, a hydroxyl group-containing monomer, and an amide group-containing monomer; and an alkyl (meth)acrylate as a monomer unit.

5. An image display device, comprising the liquid crystal panel according to claim 1.
